(19) United States
(12) Patent Application Publication
(10) Pub. No.: US 2007/0087313 A1
(43) Pub. Date: Apr. 19, 2007

(54) Method for improving relationship compatibility analysis based on the measure of psychological traits

(76) Inventor: Herb D. Vest, Dallas, TX (US)

Correspondence Address: CARSTENS & CAHOON, LLP, P O BOX 802334, DALLAS, TX, 75380, US

(21) Appl. No.: 11/549,441

(22) Filed: Oct. 13, 2006

Related U.S. Application Data
(63) Continuation-in-part of application No. 11/201,929, filed on Aug. 11, 2005.
Application No. 11/201,929 is a continuation of application No. 10/736,120, filed on Dec. 15, 2003, now abandoned.

(51) Int. Cl. G09B 19/00

(52) U.S. Cl. 434/236

(57) ABSTRACT

A method, program and system for computing an accurate compatibility index value based on an individual's measured psychological traits. Empirically derived numeric values relating to answer choices collected during psychological testing are weighted and combined to represent a probability of the individual's traits. The sum of item steps is used to derive a standardized value of the individual's trait level on the factor being measured. Rasch scaling techniques convert the scores to an interval scale to allow for invariant comparison of the various trait levels. A compatibility index value is achieved by performing multiple comparisons between two individuals, taking into account each individual's scores for each factor measured. The compatibility index is a number that is directly related to the strength of the match between the individuals.

### CROSS-REFERENCES TO RELATED APPLICATIONS

This application is a continuation-in-part of application Ser. No. 11/201,929, filed on Aug. 11, 2005, which is a continuation of application Ser. No. 10/736,120, filed on Dec. 15, 2003.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates generally to automated matching between sets of predetermined traits, and more specifically to determining the compatibility of a person or persons based on a calculated index of compatibility.

2. Description of Related Art

Determining personal compatibility through the use of psychological testing has become increasingly popular. A variety of online matching services utilize such testing to recommend appropriate matches for their members. A typical matching service requires its subscribing member to enter responses to predetermined questions. The matching service saves these responses in a database. These responses are then used to calculate some type of compatibility index which the matching service subsequently uses to determine which of the other members may or may not be compatible with the requesting member.

The methods employed by current matching services to determine the compatibility of users tend to be either simplistic or overly cumbersome. A simplistic compatibility measure may involve asking the user a fixed set of questions, with each question representing a particular trait of the individual. The compatibility analysis then consists of merely counting the various responses under the assumption that each response is equal in value. This type of analysis fails to consider the fact that not all questions and responses are equal in difficulty. For example, a question that asks, “what color is the sky?” is considerably easier than one that asks, “what is the square root of Π?” By failing to consider the fact that questions and responses are different in value, great inaccuracies are introduced into the measure of compatibility.

Other matching services attempt to increase the accuracy of the compatibility measure through various means. Some require the member to answer multitudes of questions so as to create a larger sampling of data. Still others employ statistical analysis techniques that fail to account for the varying abilities of the respondents as well as the varying degrees of difficulty of both the questions and the answer choices. In addition, the questions asked often overlap the discreet traits whose measurements are sought. The interpretation of the measured compatibility then becomes dependent on particular samples of questions. As a result, these analysis methods require extensive amounts of data to generate accurate estimations of compatibility. Thus, by increasing the number of questions the member must respond to it becomes overly cumbersome. The member answering the multitude of questions tends to tire of the process and likely either does not answer all of the questions or else answers them inaccurately. This tends to introduce even further errors into the compatibility index calculations.

In view of the aforementioned shortcomings, a need exists for a method of determining the compatibility of individuals that is highly accurate so as to increase the chances of a successful match. Further, a need exists for a method of determining the compatibility of individuals that is not cumbersome for the user. Further, a need exists for a method of determining the compatibility of individuals that considers the varying difficulty of the questions asked and the responses received. Further, a need exists for a method of determining the compatibility of individuals that considers the varying abilities of the responding users. Further, a need exists for a method of determining the compatibility of individuals that uses questions and responses that are independent of all others. The present invention fills these needs and others as detailed more fully below.

### BRIEF SUMMARY OF THE INVENTION

The present invention provides a method for calculating an accurate compatibility index value based on an individual's measured psychological traits. The method involves processing numeric values relating to answer choices collected during psychological testing. The answer choice numeric values represent empirically derived values based on particular psychological traits being measured.

Psychological tests are administered to a plurality of users. Each particular test is tailored to provide an assessment of one or more psychological traits. These tests can be administered in person, on paper, or through a website such as an on-line matching service available on the internet.

The computed compatibility index is based on several psychological traits (factors). Each factor is tested independently of the others. Some factors are further broken down into scales. Some scales are further broken down to subscales. The lowest level of each factor represents an independent question directly related to the measure of that single factor. There is no overlap between any questions regarding the factors they represent.

Each theoretically or empirically derived question is differentially weighted with respect to its difficulty. The sum of the individual's responses (i.e. steps) is used to derive a standardized value of the individual's trait level being measured. Rasch scaling techniques are used to convert the factor scores to an interval scale to allow for independent comparison of the various trait levels. Ultimately, a compatibility index value is achieved by performing multiple comparisons between two individuals, taking into account each individual's scores for each factor measured. The compatibility index is a number that is directly related to the strength of the match between the individuals.

### BRIEF DESCRIPTION OF THE SEVERAL VIEWS OF THE DRAWING(S)

The present invention will be more fully understood by reference to the following detailed description of the preferred embodiments of the present invention when read in conjunction with the accompanying drawings, in which like reference numbers refer to like parts throughout the views, wherein:

FIG. 1 is a flowchart illustrating an overview of the process by which a compatibility index is computed and matched against possible candidates in accordance with the present invention;

FIG. 2 is a flowchart illustrating in more detail the process by which a user profile is created in accordance with the present invention;

FIG. 3 is a flowchart illustrating in detail the process of applying filters to personal profiles in accordance with the present invention; and

FIG. 4 is a flowchart illustrating the process of compatibility index scoring in accordance with the present invention.

Where used in the various figures of the drawing, the same reference numbers designate the same or similar parts. Furthermore, when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the invention.

All figures are drawn for ease of explanation of the basic teachings of the present invention only; the extensions of the figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE INVENTION

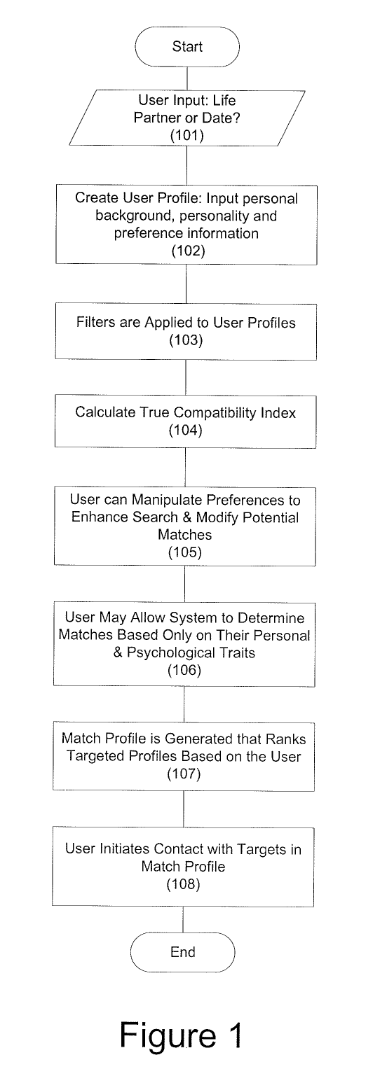

FIG. 1 is a flowchart illustrating an overview of the process by which a compatibility index is computed and matched against possible candidates in accordance with the present invention. Each of the following steps can occur in person, on paper, or through an internet website such as an online matching service.

The first step is to specify whether the user is seeking a potential life partner or merely wants to meet people to date (step 101). This decision affects the weights given to psychological and socio-demographic background characteristics in determining potential matches (explained in detail below). The user then creates a profile that includes personal background information, personality information, and preferences regarding potential partners (step 102).

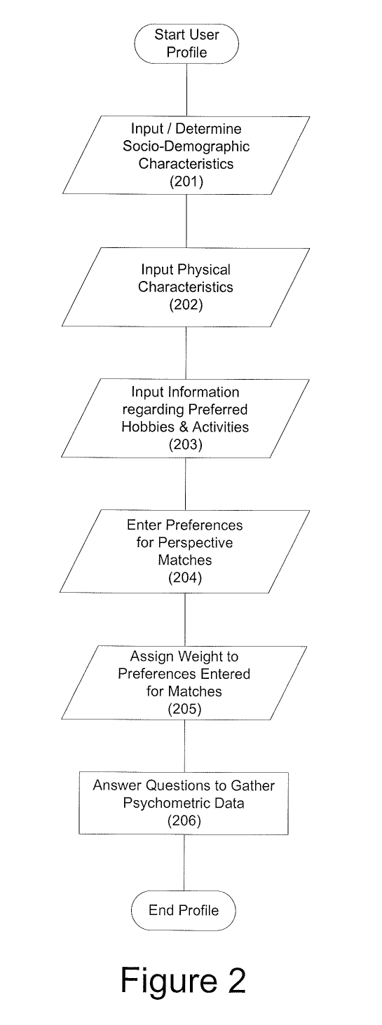

FIG. 2 is a flowchart illustrating in more detail the process by which a user profile is created. The user profile comprises four major domains: socio-demographic background, physical attributes, interests/activities, and psychological attributes (personality traits). The user begins by supplying personal socio-demographic information (step 201). Examples of socio-demographic characteristics include gender, age, language(s) spoken, ethnicity, political leanings, zip code, occupation, religion, education, and drinking and smoking habits. After supplying the relevant information, the user provides personal physical characteristic information, e.g., height, hair and eye color, body type, perceived attractiveness, any tattoos, etc. (step 202). The user then enters information about interests and preferred activities and hobbies, e.g., music, sports, movies, etc. (step 203). The user may choose from among a list of interests and activities or enter his or her unique interests.

In addition to providing personal information, the user then has the opportunity to enter preferences for the characteristics of potential partners in each of the first three domains described above (step 204). In steps 201 through 203, the user describes who he or she is. Step 204 allows the user to describe the kind of potential partner he or she is looking to meet. The user can also assign a weight to each of his or her preferences (step 205). Specifically, the user can describe the trait in question as being not important, somewhat important, or very important.

Finally, the user answers a series of questions designed to provide personal psychological data (step 206) in order to measure the user's individual trait levels. Unlike the other domains, the user does not specify partner preferences or weights for the psychological data. Instead, the user's answers are evaluated according to theoretically and/or empirically derived models. The psychological questionnaire assesses personality traits, attitudes toward people and ideas, and how the user would react in particular situations.

Returning to FIG. 1, in standard mode, the system applies filters to both the user profile and profiles of potential partners that are already stored in a database (step 103). Filters save time and resources by quickly eliminating candidates in the database who are poor matches for the user based on key characteristics. Realistically, the filters may eliminate as many as 98% of the personal profiles stored in the database. The particular background characteristics to which system level filters are applied are usually few in number and are chosen based on empirical research into which traits are most crucial to the success or failure of relationships. Examples of personal characteristics that might have system level filters include gender, age, religion, ethnicity, language, attractiveness, and location.

In addition to the system level filters, the user may add custom filters by specifying types of people he or she does not want to meet. For example, the user may specify that she is not interested in smokers or does not want to go out with lawyers or musicians. In that case, the invention will filter out anyone with those traits. Similarly, the user can negate the system level filters by specifying that a filtered trait (e.g., ethnicity) is not important, in which case the filter is ignored.

The filters are applied bilaterally. Therefore, in addition to filtering target candidates based on their personal traits and the user's stated preferences, the user himself is also filtered from the pool of targets based on his traits and the targets' stated preferences. For example, a target might be close to the user's preferred age range, in which case the target would pass through the user's filters. However, the user might be too old or young for the target's preferred age range, in which case the user would be filtered. Only if both the user and target pass through each other's filters do they remain potential candidates for each other.

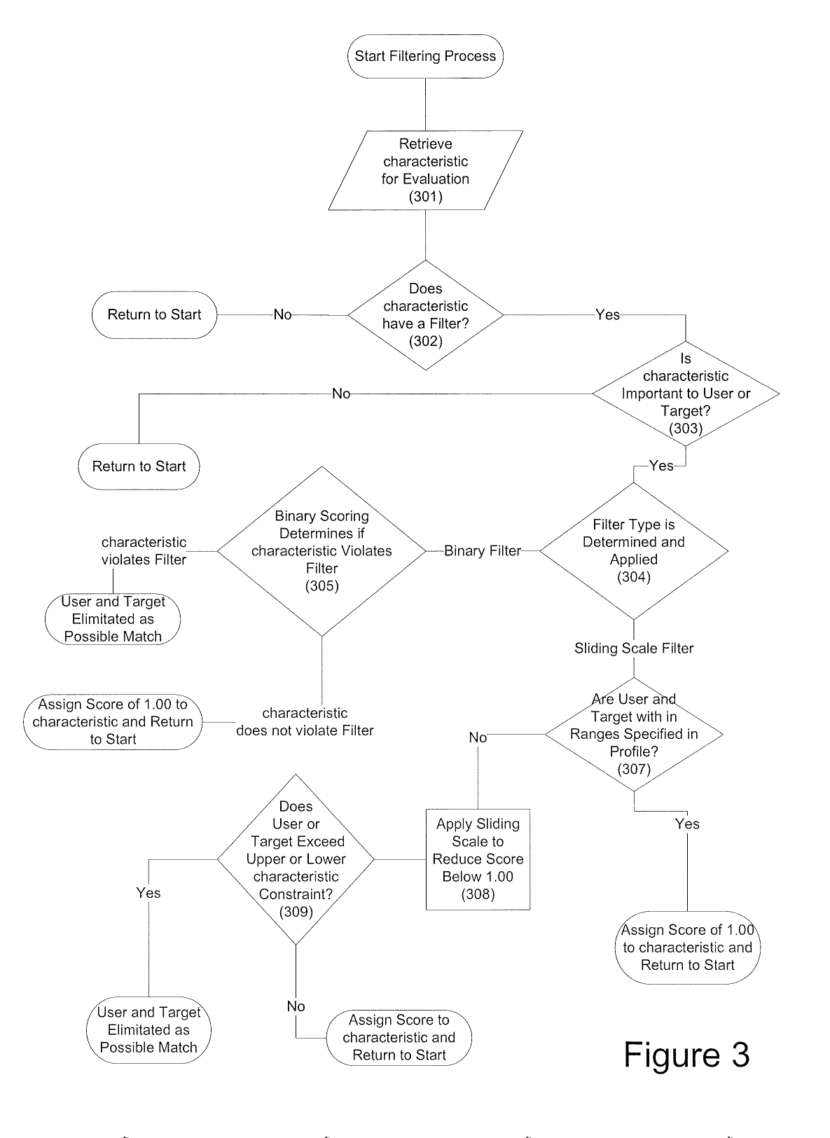

FIG. 3 is a flowchart illustrating in detail the process of applying such filters to personal profiles in accordance with the present invention. When applying the filters, the system retrieves the next characteristic to be evaluated (step 301) and determines whether the characteristic does indeed have a filter associated with it (step 302). As mentioned above, only a select number of personal characteristics are filtered. Most variables (e.g., hair and eye color, occupation, personal interests) do not have filters (unless the user has specifically added one) because differences with regard to such variables have shown not to be critical for the success or failure of a relationship. Therefore, if the characteristic in question does not have an associated filter, the system simply returns to start and retrieves the next characteristic.

If the characteristic in question does have a filter, the system determines if that characteristic is important to either the user or the target or both (step 303). The user and target's weighing of preferences affect how the filters are applied. If the characteristic has an associated filter, but both the user and the target have stated that the characteristic is not important to them, the filter is ignored and the process returns to start to retrieve the next characteristic. However, if either the user or the target states that the characteristic in question is somewhat or very important, the filter is applied and the system then determines if the filter is a simple binary filter or uses a sliding scale in conjunction with a binary filter (step 304).

If the filter does not have a sliding scale, the system uses simple binary (true/false) scoring and determines if the characteristic violates the filter (step 305). If either the user or target violates the filter rule, they are eliminated as a possible match for each other (step 305). For example, if the user is a woman looking to meet a man, the system will automatically exclude all women in the database. If the characteristic does not violate the filter, it is assigned a normal score of 1.00, and the system returns to start to retrieve the next characteristic.

If the filter has a sliding scale, it uses a combination of linear scoring and binary scoring. The linear scoring adjusts the score depending on how far the variable in question deviates from a specified value. In addition, the binary value of the variable is TRUE as long as the value is within a defined range. However, if the value deviates too far from the specified value, the filter switches entirely to binary scoring and changes the value to FALSE, excluding the candidate entirely. The upper and lower limits for binary scoring are based on empirical research, and the sliding scale is based on both empirical data and user weights. Sliding scales are applied to characteristics that naturally allow some degree of variance latitude for a successful matching of user and target, e.g., some degree of permissible difference in age, height, and distance between respective residences.

In the case of a sliding scale, the matching characteristic has a range of values specified by both the user and the target in their respective preferences, and the system determines if the user and target fall within those ranges (step 307). If the user and/or target fall within the range, the matching characteristic is assigned a normalized value of 1.00 for that person, and the system retrieves the next variable. If the user or target falls outside the other's range, the invention applies a sliding scale to reduce the values of the score below 1.00 (step 308). However, there is a limit to how much a score will be reduced.

Each characteristic with a sliding scale also has upper and lower constraints that act as absolute filters. The invention determines if the target (or user) exceeds those constraints (step 309), and if either the user or the target is too far outside the other's preference range, that person is eliminated as a potential match for the other person. If the target and the user do not exceed the respective constraints, respective adjusted scores are assigned to the characteristic for both the user and the target, and the process returns to the start.

The following example will help to illustrate the interrelationship between the sliding scale and the constraints. Users may specify an age range of people they are interested in meeting. For example, a woman might specify that she is interested in men between the ages of 30 and 40. All men in the database pool that fall within that age range are assigned a normalized value of 1.00. The empirical scoring model uses a slope of 0.15 points per year over the specified age range and a slope of 0.25 points per year under the age range. Thus, a 42-year-old man would be assigned a normalized value of 0.85 [(0.70)(0.5)+(0.5)]. A 28-year-old man would have a normalized value of 0.75. In addition to the sliding scale, there is an upper cut-off limit of 12.5 years over the specified age range, and a lower cut-off limit of 7.5 years. Therefore, any man in the database over the age of 52 would automatically be excluded as a possible match, as would any man under the age of 23.

As another example, if the user is a man who specifies that he is interested in meeting women between the ages of 30 and 40, the empirical model uses a different sliding scale, as well as different upper and lower limits. As with the example of male candidates in the above example, all female candidates in the database that fall within the 30 to 40 age range receive a normalized score of 1.00. For women over the age of 40, the model uses a slope of 0.30 points per year, while a slope of 0.15 points per year is used for women under the age of 30. Thus, a 42-year-old woman would have a normalized score of 0.70, while a 28-year-old woman would have a normalized score of 0.85. The upper cut-off limit for women over the specified range is 7.5 years, and the lower cut-off limit for women under the specified range is 10.0 years. Therefore, any woman in the database over the age of 47 would be excluded, as would any woman under the age of 20.

The specific slopes and limits used in the examples above are merely example values. The actual values will depend on the specific empirical data used to create the scoring model and might change as additional empirical data are gathered and the model is refined. However, the above examples illustrate the important point that the values may vary between genders depending upon the characteristic being scored.

Returning to FIG. 1, after the filters have been applied to the user and the targets in the database, the invention calculates a True Compatibility Index (TCI) score for both the user and each remaining target that passed through the selection filters (step 104). The User TCI measures how well the target matches the user, while the Target TCI measures how well the user matches the target. In addition to the individual User and Target TCIs, there is also a paired TCI that measures the overall match between the user and target. It is the paired TCI score that is presented to the user as the final compatibility score.

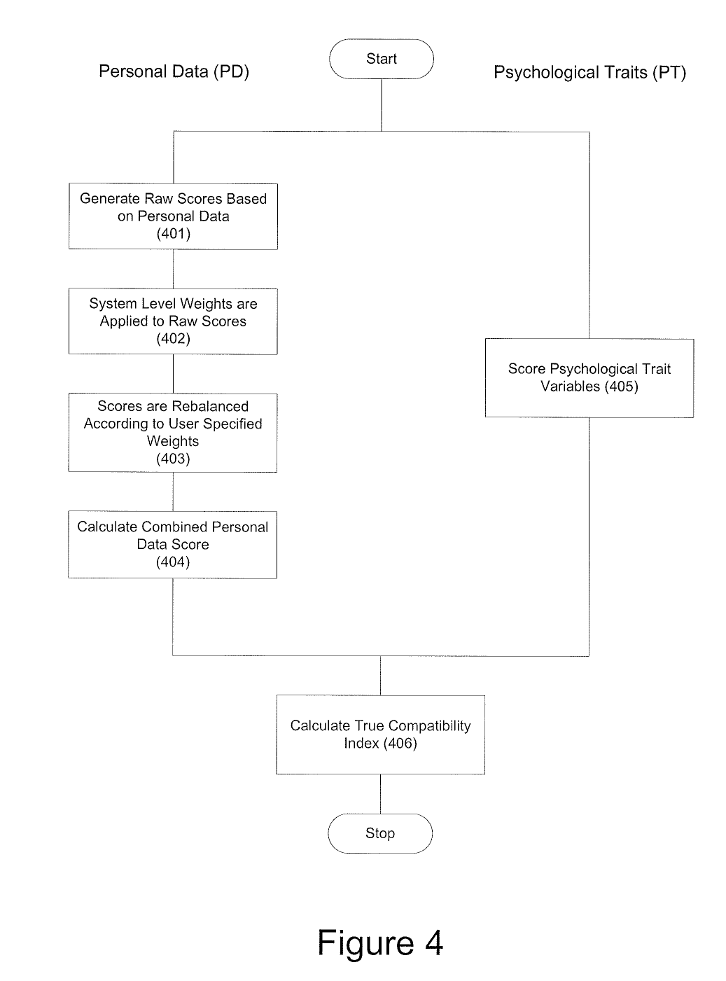

Referring now to FIG. 4, a flowchart illustrating the process of compatibility index scoring is depicted in accordance with the present invention. In calculating the TCI score, the personal profile domains are separated into two major categories. The socio-demographic, interests/activities, and physical characteristics are all grouped under Personal Data (PD). The personality information is classified and scored separately as Psychological Traits (PT).

For the Personal Data, raw scores are generated for the variables (step 401). The variables are scored according to algorithms that compare personal information to user preferences. Each personal trait may have its own algorithm. For example, eye color is scored in a binary manner, since the target either does or does not meet the user's preference. However, unlike filtered traits (e.g., gender) eye color is not a basis for excluding the target as a possible match (unless the user specifically added a filter for this trait, as explained above). Therefore, rather than filtering the target, points are added or subtracted from the target's compatibility score depending on whether it conforms to the user preference and how important the trait is to the user.

Other traits (e.g., height or income) are scored according to a sliding scale similar to that described in relation to FIG. 3 but without the upper and lower constraints. The scores are adjusted down the further the target is from the user's preferred range, but no excluding filters are applied (unless the user has added filter constraints for these traits).

System-level weights are then applied to the raw scores (step 402). These weights are based on statistical analyses of survey data establishing the relative importance of each trait to a cross section of potential users. After system-level weights are applied, the scores are rebalanced according to user specified weights to produce a score for each PD domain (step 403). For example, if the user specifies a trait as not being important, it is ignored. If the user specifies that trait as being somewhat important, it receives a weight of 1. If the trait is specified as very important, it receives a weight of 2. After the invention calculates scores for the individual PD domains (socio-demographic, physical traits, and interests), it calculates a combined PD score (step 404).

Next, the system works to develop a PT score (step 405). The psychological assessment is broken down into several factors. These factors comprise characteristics such as personality, communication, sex, romance, and commitment. Some factors are further reduced to scales and subscales. For example, a measure of personality may be reduced to theoretically and/or empirically derived questions concerning a user's open-mindedness. The measure of open-mindedness may be further reduced to questions concerning open-mindedness with respect to the user's ideas and/or feelings. The degree of granularity depends upon the amount of detail required to accurately measure a particular factor.

In the present invention, each question is differentially weighted with respect to its relative measure of the respective factor. The questions are also chosen such that there is no item overlap between the various factors being measured. For example, questions pertaining to personality apply only to the measure of the user's personality trait. This serves to reduce the errors inherent in a system in which the questions are not clearly defined to apply to a single trait.

The system captures and stores each of the user's answers in a database for further analysis. The present invention requires the user to answer the various questions relevant to the measured traits. Each question presents the user with at least two discrete answer choices. These answer choices are assigned step values to assist in calculation of the overall trait level. For example, if a user is presented with answer choices “A,” “B.” “C,” and “D” and the user chooses answer “C,” then the user has “stepped over” answers “A” and “B.” Thus, answer choice “C” is assigned a step value of two. Likewise, if the user chooses answer choice “A” then the user has not “stepped over” any other answer choice. Answer choice “A” consequently receives a step value of zero.

The step value of the user's answer choices is used along with empirically derived weights to estimate the user's trait level. Because the questions and associated answer choices vary in difficulty, their response values are converted to logits. This logarithmic transformation allows direct measurement of observations rather than merely a simple count. By allowing for actual measurement of psychological observations, the present invention accounts for the varying degree of difficulty of the questions and answer choices. Thus, the overall errors in the trait level calculation are reduced.

The present invention also takes into account the user's ability to answer any given question. For example, a user with an advanced education may have little difficulty with certain questions that would be difficult for one with little or no education. This difference in ability can likewise present errors into a calculation of a given trait level. By taking a logarithmic transformation of the probability that a user will select a particular answer choice, this difference in ability is factored into the calculation and the overall error is reduced.

The user's answer choices relating to a given factor are then combined to derive a standardized value of that user's trait level. Rasch scaling techniques are employed in this calculation to achieve a more accurate estimate of the probability that the user possesses this particular trait.

The probability estimates yielded from a Rasch model are more accurate than simple percentage expressions of probability more commonly used as estimates of trait level. The probability estimate is a sum of the logits representing both question response (item) levels and user ability for all items in a given trait. This probability estimate reflects the probability that the user will endorse a particular answer choice for the given trait. A high probability estimate reflects that the user is more likely than his or her counterparts (having a lower probability estimate) to endorse any given question response. Likewise, an item with a low log-odds level (representing an “easy” question) is more likely to be endorsed than one with a high log-odds level (a “hard” question). Each item represents an unbiased estimate of the user's trait level (βᵤₛₑᵣ).

Overall, this scaling method provides several advantages over conventional scaling methods in measuring psychological traits:
(1) each question is not assumed to be equal in value to a person's score;
(2) each answer choice is differentially weighted to produce a monotonic gradient of measurement;
(3) interpretation of a person's score is not dependent upon a particular sample of items;
(4) interpretation of item parameters is not dependent upon a particular sample of users;
(5) endorsement of one item is not dependent upon responses to previous items;
(6) indices of model fit are available to validate the unidimensionality of scale; and
(7) standard errors are estimated for each person/item, rather than providing one estimate per sample.

If a user possesses a particular characteristic, e.g., if that person is comfortable expressing emotions, his or her answers will tend to display a consistent pattern. However, if there is significant variability among a group of answers related to a particular trait, then that user will have a higher standard error (variance, σᵤₛₑᵣ) associated with the user's trait level (βᵤₛₑᵣ). This variance is computed for use in later compatibility index calculations.

Based on the psychological test trait level calculations described above, the invention is able to define the user (and targets in the database) according to each factor. Each psychological trait is compared between the user and each target, and a score is assigned to that trait according to compatibility and importance. Unlike the PD score, the PT score may not involve user-defined weights or preferences. Instead, PT scoring may be performed according to matching algorithms derived from empirical research on relationships.

In the present embodiment, the PT score is calculated using the probability estimates determined by the Rasch scaling methods previously discussed. For a given pair of individuals (i.e. user and a potential target match), it represents the difference between the individuals' trait-level estimates (β_{target}−βᵤₛₑᵣ) divided by the square root of a combination of their individual variances (σ²_{target}+σ²ᵤₛₑᵣ)^{1/2} relative to the respective trait-level estimate. This measures if the differences between the user and target are greater than what would be expected to occur by chance.

In the PT score calculation, the user is placed at the 50^{th} percentile and a bell curve is fit around the user to represent the distribution of potential targets. The bidirectional difference between the user and a target on a given trait is associated with a percentile rank for that match in the overall population of targets.

The True Compatibility Index (TCI) score is then calculated by summing the differentially weighted PT scores between the user and target. A high TCI value represents a greater probability of a potentially successful match.

In yet another embodiment, once the PD and PT scores have been calculated the TCI may be calculated using domain level weights for both the PD and PT scores (step 406). The domain weights refer back to step 101, in which the user chooses whether he or she is seeking a dating relationship or a life partner. The relative importance of psychological traits versus socio-demographic and physical characteristics varies not only with the seriousness and intended length of the desired relationship but also with gender. The following table is an example that illustrates the weight assigned to the PT score relative to the PD score, depending on the type of relationship and the gender of the user:

| | Life | Dating |
|---|---|---|
| Male | 1.5 | 1 |
| Female | 2.25 | 1.5 |

For example, if a man specifies in step 101 that he is seeking a life partner, then the PT score is weighed one and a half times the averaged PD score. However, if the user is a woman seeking a life partner, the PT score is weighed two and a quarter times the PD score. This reflects the empirical observation that for serious longer-term relationships, psychological traits are more important than socio-demographic characteristics, physical characteristics, and interests and hobbies. Furthermore, the importance of psychological traits is greater for women than for men. The specific numbers used in the chart are merely examples based on empirical research and are therefore subject to change as new research is performed.

Returning to FIG. 1, after the paired TCI is calculated, the invention generates a match profile that ranks the targets according to how well they match the user (step 107). All target candidates in the database that are not excluded during filtering in step 103 are included in the ranked profile according to their respective TCI scores. In addition to the TCI score, the user is also provided with a detailed breakdown for each person listed in the ranked profile. This breakdown specifies how the user is or is not compatible with the target in regard to particular psychological, demographic and physical traits. Because it is highly improbable that two people are perfectly compatible with each other, the invention provides users with a detailed picture of how good a “fit” they are for each other and why. It is then up to the user to decide whether or not to initiate contact with targets in the match profile (step 108).

In addition to the standard mode of generating potential matches for the user, the invention provides alternate methods for finding potential matches. In the advanced custom search, the user is given the opportunity to manipulate his or preferences to find different matches (step 105). With the advanced custom search, the user can change preferences, preference weights (i.e., not important, very important) and can even ignore psychological characteristics. The resulting match profiles can then be added to the match profile generated in step 107. The user can employ the advanced custom search option to create multiple match profile lists that can be stored under the user's account along with the match profile generated in the standard operating mode.

At the other end of the spectrum, the invention also provides the option of generating a match profile based solely on the user's personal and psychological traits, without regard to user preferences or weights (step 106). This auto search function simply matches targets to the user based on the traits the user has, while ignoring which specific traits the user is seeking in others. As with the custom search, the auto match profile can be stored along with the other match profiles in step 107.

The disclosed invention need not be limited for use in online dating services. In yet another embodiment, the invention can be used to determine the probability of a successful match in an employment situation. For example, prospective employees can be required to answer the aforementioned psychological test questions. Their trait levels can then be calculated using the invention. A comparison can then be made between the trait levels required for a particular position and the applicant pool. The TCI would then represent a measure of the potentially successful match of a particular applicant with the traits required of the job position. Conversely, a database could be maintained with trait levels required for a multitude of available positions with different employers. An individual seeking a position could then compare his or her own trait levels with those sought by the various employers. The TCI would then represent a measure of the potentially successful match of a particular employer with the applicant. Thus, the disclosed invention has application in any situation wherein psychological traits are being matched between two individuals, two entities, or even an individual and an entity.

The description of the present invention has been presented for purposes of illustration and description and is not intended to be exhaustive or limited to the invention in the form disclosed. Many modifications and variations will be apparent to those of ordinary skill in the art. The embodiment was chosen and described in order to best explain the principles of the invention, to illustrate the practical application, and to enable others of ordinary skill in the art to understand the invention for various embodiments with various modifications as are suited to the particular use contemplated.

We claim:

1. A method for improving relationship compatibility analysis among a plurality of individuals based on the measure of various psychological traits, the method comprising the steps of:
(a) providing a plurality of questions, each of the questions having a corresponding discreet answer set, the questions and corresponding answers each relating to a particular predetermined psychological trait to be measured;
(b) collecting and retaining a first individual's response to each of the answer sets;
(c) calculating a first response score relative to each psychological trait tested, based on the first individual's responses;
(d) collecting and retaining a second individual's response to each of the answer sets;
(e) calculating a second response score relative to each psychological trait tested, based on the second individual's responses; and
(f) calculating a relationship compatibility index value by combining the first response scores with the second response scores.

2. The method of claim 1 wherein the questions are empirically derived.

3. The method of claim 1 wherein the compatibility index value is the difference between the first and the second response scores divided by the square root of a combination of the first and the second response score's respective variance.

4. The method of claim 1 wherein one of the first and the second individuals is a fictitious entity, wherein the fictitious entity's responses are made based on an ideal set of desired responses.

5. The method of claim 1 wherein the response scores are probability estimates calculated using a Rasch model scaling of log-odds ratios.

6. The method of claim 1 wherein each of the questions utilize at least two discrete answer choices.

7. The method of claim 1 wherein the plurality of questions utilize at least two discrete answer choices, the answer choices providing a step value that is utilized in computing the response scores.

8. The method of claim 1 wherein the first and the second response scores each represent the log-odds that the respective individual will endorse a particular answer choice for the psychological trait that the respective response score is based upon.

9. The method of claim 1 wherein the compatibility index is a linear combination of weighted estimates.

10. The method of claim 1 wherein the compatibility index is a value in the range of 0 to 100 representing the quality of the match in the overall population of individuals tested.

11. The method of claim 1 wherein the response scores include a factor representing the respective individual's abilities to answer the question and a factor representing the relative difficulty of the question asked.

12. A method for improving the accuracy of online matching service relationship compatibility scoring among a plurality of individuals based on the measure of various psychological traits, the method comprising the steps of:
(a) providing a plurality of questions, each of the questions having a corresponding discreet answer set, the questions and corresponding answer set each relating to a particular predetermined psychological trait to be measured;
(b) collecting and retaining a first individual's response to each of the answer sets;
(c) calculating a first response score relative to each psychological trait tested, based on the first individual's responses;
(b) collecting and retaining a second individual's response to each of the answer sets;
(c) calculating a second response score relative to each psychological trait tested, based on the second individual's responses; and
(d) calculating a relationship compatibility index value by combining the first response scores with the second response scores.

13. The method of claim 12 wherein the matching service is selected from the group consisting of a dating service, an employment service, a recruiting service, a staffing service, and a travel service.

14. The method of claim 12 wherein either the first or the second individual is a fictitious entity, wherein the fictitious entity's responses are made based on an ideal set of desired responses.

15. The method of claim 12 wherein the response score is a probability estimate calculated using a Rasch scaling model of log-likelihood ratios.

16. The method of claim 12 wherein each of the questions utilizes at least two discrete answer choices.

17. The method of claim 12 wherein each of the questions utilize at least two discrete answer choices, the answer choices providing a step value which is utilized in the first and the second response score calculations.

18. The method of claim 12 wherein the first and the second response scores represent the logarithmic odds that the respective individual will endorse a particular answer choice for the psychological trait that the respective response score is based upon.

19. The method of claim 12 wherein the compatibility index is a linear combination of weighted estimates.

20. The method of claim 12 wherein the compatibility index is a value in the range of 0 to 100 representing the quality of the match in the overall population of individuals tested.

21. The method of claim 12 wherein the questions are empirically derived.

22. The method of claim 12 wherein the first and the second response scores include a factor of the respective individual's abilities to answer the respective question and a factor of the relative difficulty of the question asked.

23. A method for improving the accuracy of finding suitable destinations for an individual with an online travel service, said method comprising the steps of:
(a) providing a plurality of questions, each of the plurality of questions having a corresponding discreet answer set, the questions and corresponding answer set each relating to a particular predetermined psychological trait to be measured, the predetermined psychological trait relating to one of a plurality of travel destinations;
(b) collecting and retaining a fictitious traveler's response to each answer set, the fictitious individual's responses being based on an ideal set of desired responses;
(c) calculating a first response score relative to each psychological trait tested, based on the fictitious traveler's responses; and
(d) collecting and retaining the individual's response to each answer set;
(e) calculating a second response score relative to each psychological trait tested, based on the individual's responses;
(f) calculating a destination compatibility index value by combining the first response scores with the second response scores.
(g) presenting the results of the destination compatibility index value.

24. A method for determining the compatibility between a prospective employee and a particular employment position based on the measure of various psychological traits, the method comprising the steps of:
(a) providing a plurality of empirically derived questions, each of the questions having a corresponding discreet answer set, the questions and corresponding answer set each relating to a particular predetermined psychological trait to be measured;
(b) calculating an ideal response score relative to each psychological trait tested, based on the ideal psychological traits for a given employment position;
(b) collecting and retaining an applicant's response to each of the answer sets;
(c) calculating an applicant response score relative to each psychological trait tested, based on the applicant's responses;
(d) calculating a prospective employee compatibility index value by combining the ideal response scores with the applicant's response scores; and
(e) presenting the results of the prospective employee compatibility index value.

25. An automated system for calculating a relationship compatibility index, the index representing the strength of a potentially successful match, the system comprising:
a first means for presenting a plurality of empirically derived questions to an individual;
a second means for collecting the individual's responses to the plurality of questions;
a third means for retaining the responses;
a fourth means for computing a response score based on the responses;
a fifth means for computing a compatibility index value based on a combination of the individual's responses and at least one of a plurality of stored responses;
a sixth means for computing potential matches based on the compatibility index; and
a seventh means for presenting the potential matches to the individual.
